(19) United States
(12) Patent Application Publication
(10) Pub. No.: US 2010/0077984 A1
(43) Pub. Date: Apr. 1, 2010

(54) Reciprocating piston combustion engine

(76) Inventors: Rupert Baindl, Geretsried (DE); Helmut Betzmeir, Ottobrunn (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/919,372

(22) PCT Filed: Apr. 10, 2006
(86) PCT No.: PCT/EP2006/003282

§ 371 Date: Jul. 23, 2009

(30) Foreign Application Priority Data
Apr. 29, 2005 (DE) 102005020064.8

(51) Int. Cl. F02B 75/32

(52) U.S. Cl. 123/197.4

(57) ABSTRACT

A reciprocating piston combustion engine with at least one cylinder (2) in which a piston (1) is located, so it can be moved in a reciprocating manner; a first crankshaft (4); a second crankshaft (6); wherein the first crankshaft (4) and the second crankshaft (6) extend parallel to each other and rotate synchronously in opposite directions; wherein the rotation axes (X, X′) of the two crankshafts (4, 6) extend parallel to a common cylinder midplane (Z) and laterally offset relative to it; wherein a first piston rod and second piston rod (3, 5) are arranged at the reciprocating piston (1), so that the first piston rod (3) is pivotably connected to the to the reciprocating piston (1) with its first end and rotatably connected to a crankpin (40) of the first crankshaft (4), and that the second piston rod (5) is pivotably connected with its first end to the reciprocating piston (1), and rotatably connected to the crankpin (60) of the second crankshaft (6) with its second end, and wherein the crankshafts (4, 6) are engaged with each other through synchronizing gears (42, 62), is characterized in, that the two crankshafts (4, 6) are supported in at least one common bearing block (7; 107; 207); that the bearing block (7, 107, 207) is made of a material with a first thermal expansion coefficient, that the synchronizing gears (42, 62) are made of a material with a second thermal expansion coefficient, and that the dimensions in the radial direction of the bearing block (7; 107; 207) and of the synchronizing gears (42, 62), and the first and the second thermal expansion coefficients, are matched in such a manner, that the thermal expansion of the bearing block (7; 107; 207) occurring between the two rotation axes (X, X′) of the bearing block (7; 107; 207) is substantial equal to the thermal expansion of the synchronizing gears (42, 62).

The object of the invention regards a reciprocating piston combustion engine according to the pre-characterizing part of patent claim 1.

Such a reciprocating piston combustion engine is known e.g. from DE 103 483 45.4 A1 and is commonly referred to as a twin crankshaft engine.

The two crankshafts of state of the art twin crankshaft engines are supported in a crankcase, enclosing the bottom part of the engine, as e.g. shown in U.S. Pat. No. 5,870,979 A or DE 40 13 754 A1. Therefore the crankcase of these twin crankshaft engines must be provided particularly stiff and massive.

In state of the art twin crankshaft engines the torque generated by the engine is transferred trough one or both of the crankshafts, as it is known e.g. from U.S. Pat. No. 5,870,979 A or DE-OS 1 756 759 etc., wherein the respective crankshafts transferring the torque are equipped with additional gears, coupled with a transmission, which results in a considerable overall length, and thereby in an increased weight of the twin crankshaft engine.

It is the objective of the present invention, to provide a reciprocating piston combustion engine according to the pre-characterizing part of patent claim 1, which has a compact design, which is weight optimized, and which is also capable of developing high power outputs.

This objective is achieved in a reciprocating piston combustion engine of this kind through the features of patent claim 1.

Supporting both crankshafts in one bearing block makes it possible, not to have to transfer the forces, acting in a radial direction between the two crankshafts, through the crankcase structure, but to receive them directly in the bearing block. The crankcase can thus be designed in a weight saving manner. The particular selection of the materials of the bearing block and of the meshing synchronizing gears, wherein the dimensions of the bearing block and the synchronizing gears in radial direction, and also the first thermal expansion coefficient of the material of the crankcase, and the second thermal expansion coefficient of the material of the synchronization gears are matched, so that the thermal expansion of the bearing block between the two axes is substantially equal to the thermal expansion of the synchronization gears, furthermore provides for constant tooth clearance between the two meshing synchronizing gears, which does not change, even under the significant temperature fluctuations that are encountered in high performance engines. Thus gear tooth wear and noise generation are notably reduced.

A preferred refinement is characterized in that the crankshafts are made from a material with a third thermal expansion coefficient, and that the dimensions of the bearing block, the crankshafts and the synchronizing gears in radial direction, as well as the first, the second and the third thermal expansion coefficient are matched in such a manner, that the thermal expansion of the bearing block and the crankshaft sections supported therein, is substantially equal to the thermal expansion of the synchronizing gears and that section of the crankshaft on which the synchronizing gears are mounted. Herewith also the thermal properties of the crankshaft are taken into consideration when compensating for the thermal effects on gear tooth clearance.

It is advantageous in particular in the context of this invention, when the bearing block and the synchronizing gears respectively are made from material with the same thermal expansion coefficient, wherein preferably also the crankshafts are made from a material with this thermal expansion coefficient.

It is advantageous in particular, when the bearing block and the synchronization gears are made from the same material and when also the crankshafts are advantageously made from the same material.

In a preferred embodiment at least two bearing blocks are provided for supporting the crankshafts.

The invention is practiced in a particularly advantageous manner in a reciprocating piston combustion engine with at least two in-line piston/cylinder units.

A particularly compact embodiment of a reciprocating piston combustion engine according to the invention can be achieved by the bearing block supporting at least one of the drive gears which meshes with at least one of the synchronizing gears.

In this case it is particularly advantageous, if the drive gear is also made from a material with a thermal expansion coefficient, which is equal to the thermal expansion coefficient of the bearing block.

Preferably the drive gear and the shaft supporting the drive gear in the bearing block are made from the same material as the bearing block.

A further inventive measure by which a reciprocating piston combustion engine according to the invention or a reciprocating piston combustion engine according to the pre-characterizing part of patent claim 1 can be provided in a particularly light and compact manner is characterized by both crankshafts being supported in at least one common bearing block, with the bearing block directly connected to the cylinder and/or cylinder head through mounting means. This inventive measure can also be implemented by itself in state of the art twin crankshaft engines, independently from the special thermal characteristics described above.

In this design, the forces occurring in the operation of the reciprocating piston combustion engine between the cylinder head and the bearing block are not transferred through the crankcase, but directly through mounting means between the bearing block and the cylinder, or the cylinder head, so that the crankcase can be provided very light, and the material for the crankcase does not have to be selected according to stability criteria, but can be selected according to weight and/or heat transfer criteria.

Preferably the bearing block thereby comprises a protrusion pointing towards the cylinder, having receiving means for mounting elements for the cylinder and/or the cylinder head. The protrusion, which can be provided integrally with the bearing block or separate from it, transfers the forces directly to the bearing block.

The invention is subsequently explained in more detail with reference to the drawings, where is shown in:

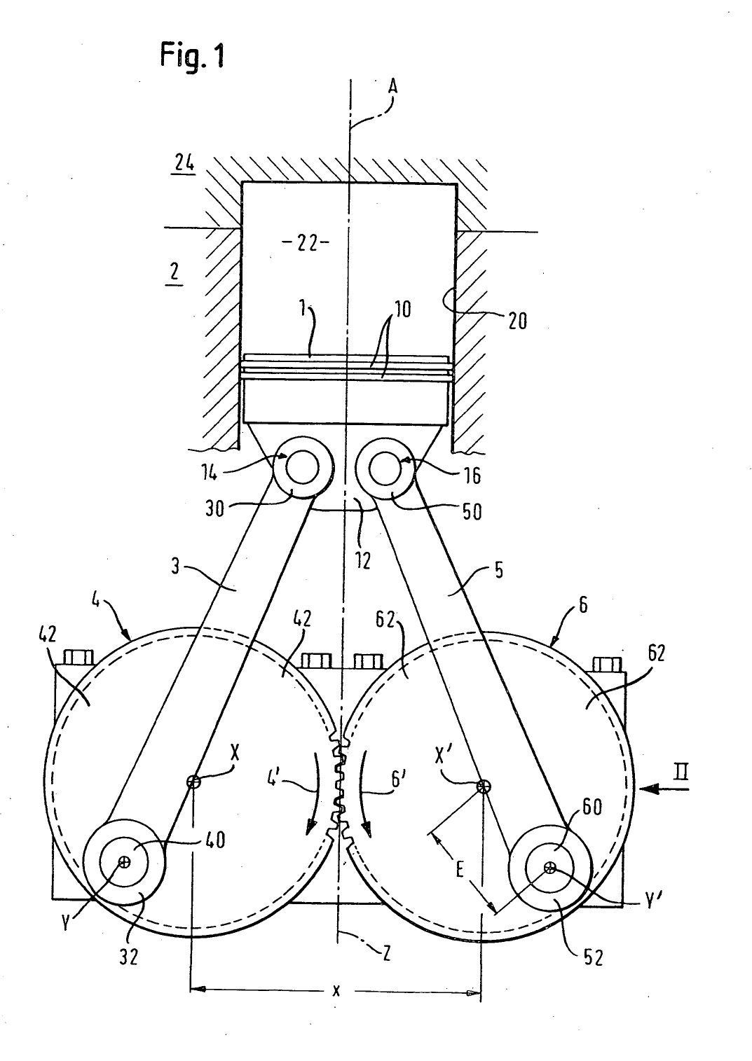

FIG. 1 a schematic frontal view of a reciprocating piston combustion engine according to the invention in the direction of the crankshaft axes;

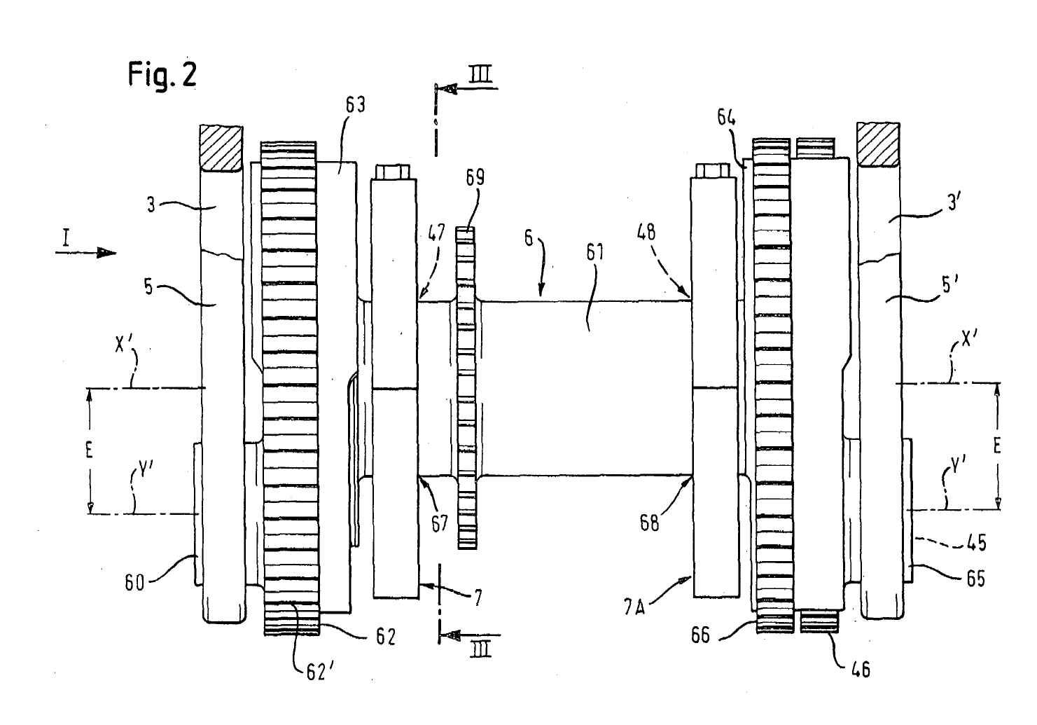

FIG. 2 a sectional side view, in the direction of arrow II in FIG. 1;

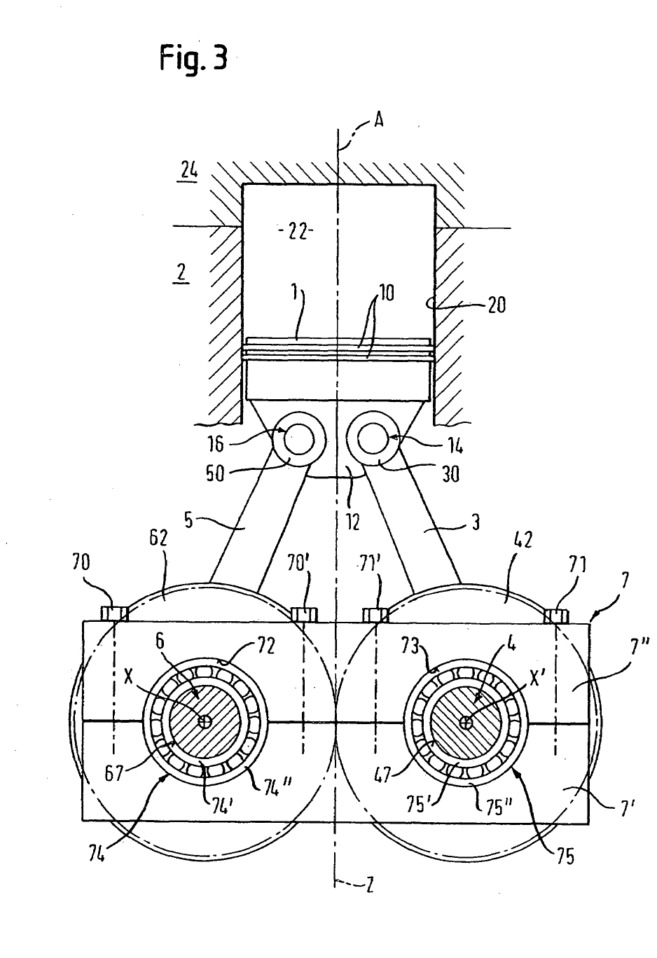

FIG. 3 a sectional view in the direction of arrow III in FIG. 2;

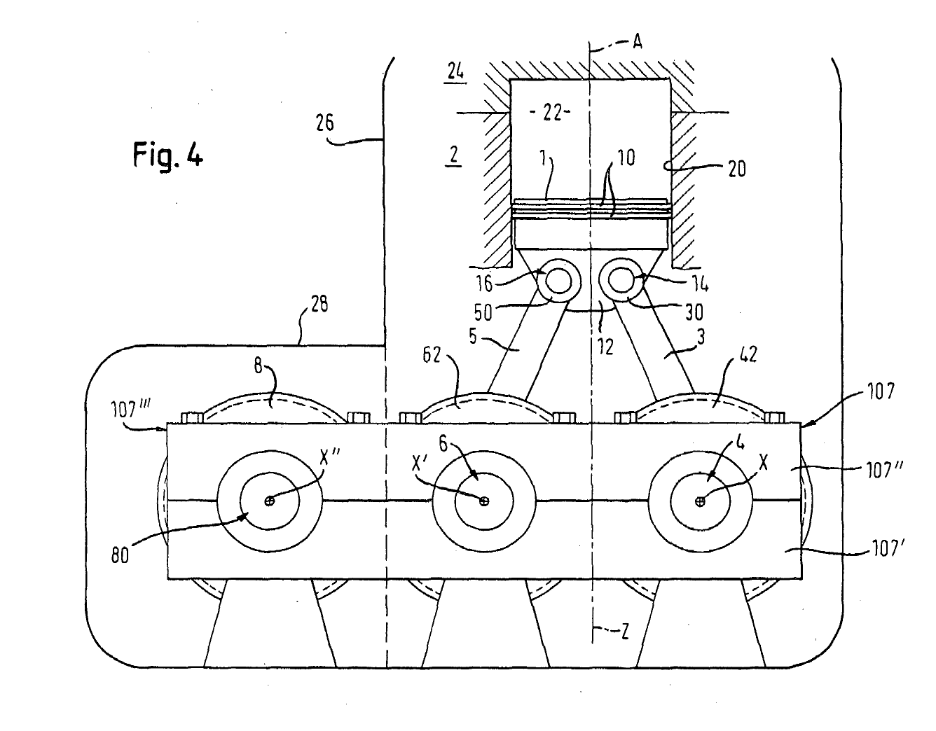

FIG. 4 an alternative embodiment with a lateral power output and

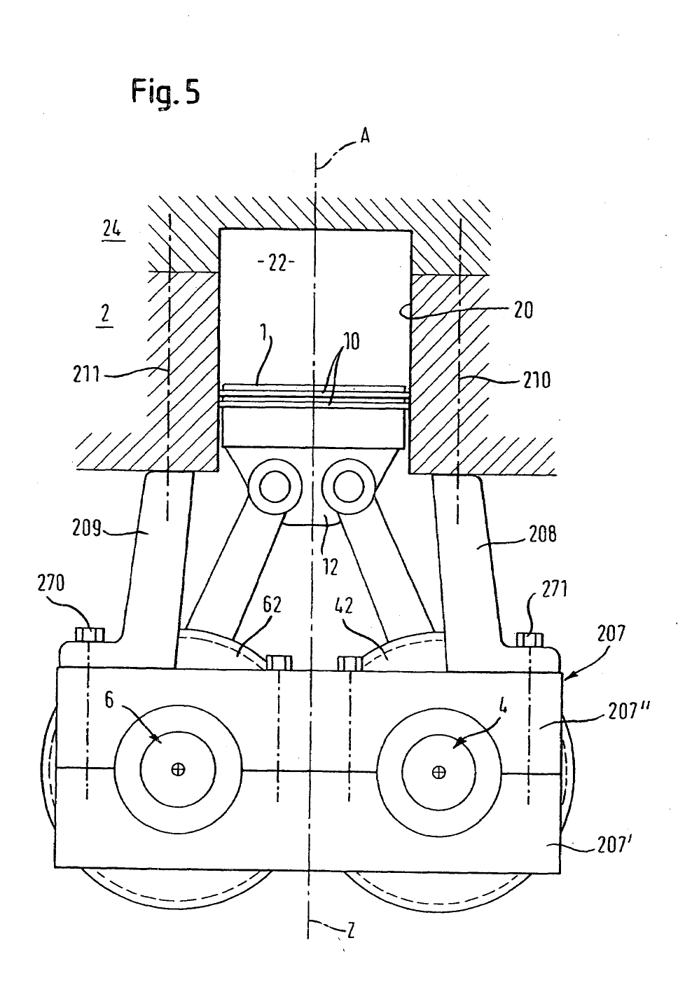

FIG. 5 an additional alternative embodiment with a bearing block mounted to the cylinder.

In FIG. 1 a schematic partial sectional frontal view of a reciprocating piston combustion engine according to the invention is shown. A piston 1 is received inside the bore 20 of a cylinder 2 provided with a cylinder head 24, so it can be moved in a reciprocating manner along a cylinder axis A. The piston 1 is sealed relative to the cylinder bore 20 with a plurality of piston rings 10 in a conventional manner.

A combustion chamber 22 is enclosed by the bore 20 and the piston 1 in a conventional manner, wherein the combustion of the fuel mixture takes place.

The intake valves, exhaust valves, spark plugs or glow plugs and injection devices, typically provided in a cylinder head 24 are not shown in detail, since they represent technology generally known to a person skilled in the art.

At the end pointing away form the combustion chamber 22, the piston 1 is provided with a piston bar 12, where two piston rod bearings 14, 16 are provided, laterally offset relative to each other and relative to the cylinder axis A.

At the first piston rod bearing 14 a first piston rod 3 is pivotably connected through a piston rod top end 30 provided at its first end. At the other end of the piston rod 3 a piston rod big end 32 is provided, which is rotatably connected to a first crankpin 40 of a first crankshaft 4, rotatable around an axis X.

In an identical manner, at the second piston rod bearing 16 of the piston 1, a second piston rod 5 is connected in a pivotable manner to a first piston rod top end 50. The piston rod 5 is connected through a piston rod big end 52 provided at its other end in a rotatable manner to a first crankpin 60 of a crankshaft 6 rotating around an axis X′.

The two crankshafts 4, 6 are engaged in a meshing manner through gears 42, and 62 forming synchronization gears. This engagement of the gears 42, 62 provides for a counteracting synchronous rotation of the crankshafts 4, 6 in the direction of the arrows 4′ and 6′. The position of the crankpins 40, 60, and consequently the arrangement of the piston rods 3, 5 is symmetrical relative to the piston axis A, or in a multi-cylinder engine it is symmetrical to a cylinder midplane Z established by the row of the individual cylinder axes A. The configuration of a twin-crankshaft, or twin-piston-rod engine shown in FIG. 1 with two parallel, synchronously counter-rotating crankshafts 4, 6 provides for low-friction movement of the piston 1 in the cylinder bore 20 without tilting laterally relative to the cylinder axis A.

The design of the crankshaft is subsequently explained with reference to FIG. 2, wherein in FIG. 2 only a cutout of the view according to the arrow II in FIG. 1 is shown illustrating the crankshaft 6. The design of the crankshaft 4 is analogous to the crankshaft 6.

FIG. 2 shows the crankshaft 6 of a reciprocating piston combustion engine provided as a two cylinder engine according to the present invention.

The crankshaft 6 has a central tubular middle section 61, aligned coaxial with the axes X″ of the crankshaft 6. At one axial end, the tubular section 61 transits into a first frontal section 63, with a diameter that is enlarged relative to the tubular section 61. On the circumference of the first frontal section 63, the gear 62 is provided, which meshes with the gear 42 of the crankshaft 4 for synchronization and power transmission. The gearing 62″of the gear 62 can be straight or, preferably, diagonal.

At the front face of the first frontal section 63 facing away from the tubular section 61, the crankpin 60 is provided, whose axis Y″ is laterally offset relative to the crankshaft axis X″ by an eccentricity E. The piston rod 5 is rotatably mounted to the crankpin 60. In FIG. 2 also the piston rod 3 of the crankshaft 4, located behind the piston rod 5 in viewing direction, can be seen.

At its second end, the tubular section 61 transitions into a second frontal section 64, whose diameter relative to the diameter of the tubular section 61 is also enlarged, and preferably corresponds to the diameter of the first frontal section 63. At its front face pointing away from the tubular section 61, a second crankpin 65 is mounted to the second frontal section 64, also laterally offset relative to the crankshaft axis X″ by the eccentricity E, its axis being identical with the axis Y″ of the first crankpin 60.

On the second crankpin 65, a second piston rod 5″ of a second piston cylinder array of the two cylinder engine is shown. Also the first piston rod 3′, rotatably mounted to another crankpin 45 of the mirror symmetrical first crankshaft 4 of the second piston cylinder array, is visible in FIG. 2. The two piston rods, 3′, 5″, are pivotably mounted via piston rod bearings 94, 96 to the piston (not shown) of the second piston cylinder array. Also the two crankpins 40, 45 of the first crankshaft 4 are located on a common axis Y, which is also offset from the crankshaft axis X by an eccentricity E.

In FIG. 2 it can furthermore be seen, that on the outer circumference of the second frontal section 64, an additional gear 66 is provided, which is used for driving auxiliary equipment, e.g. an oil pump. Also on the analogous second frontal section 44 of the first crankshaft, a gear 46 is located, which is located offset from the gear 66, in the direction of the crankshaft axes X, X′, so that the two gears, 46 and 66, do not interfere with each other and do not mesh with each other. The gear 46 of the first crankshaft 4 is also used for driving additional auxiliary equipment, e.g. a hydraulic pump, or a supercharger.

Directly adjacent to the first frontal section 63 and the second frontal section 64, a respective bearing section, 67, 68, is provided on the tubular section 61 of the second crankshaft 6. With the bearing sections 67, 68, the crankshaft 6 is supported in a conventional manner in straight or roller bearings in the bearing blocks, 7, 7A, of the reciprocating piston combustion engine. This bearing very close to the frontal section 63, 64, and thereby close to the crankpins, 60, 65, provides for an ideal bending moment distribution in the crankshaft 6, since the radial forces transferred by the respective piston rods 5, 8, are supported in axial direction close to the location of transfer (the crankpin) in the crankshaft bearing. Furthermore, this arrangement of the bearing sections, 67, 68, in the middle section of the crankshaft 6, provided as a face crankshaft, thus in the area of the tubular section 61, thus provides for a very compact design of the crankshaft 6 and thereby of the complete reciprocating piston combustion engine. The bearing of the first crankshaft 4 is analogous.

Between the first bearing section 67 and the second bearing section 68, a sprocket 69 is provided on the tubular section 61 of the crankshaft 6, which is used for driving a timing chain for the camshaft (not shown), provided in the cylinder head 24 for actuating the valves (not shown). The sprocket 69 is provided only on the second crankshaft 6 in the figures, but it can also be provided on the first crankshaft 4.

The design of the bearing blocks, 7, 7A, is described in more detail with reference to FIG. 3, showing a view opposite to the view shown in FIG. 1, in direction of the arrows III in FIG. 2. The bearing block 7 is described, wherein the bearing block 7A is analogous.

The bearing block 7 is split in a plane defined by the crankshaft axes X, X″, and is thereby divided into a lower bearing block section 7″ and an upper bearing block 7″. The two bearing block sections, 7″and 7″, are mounted to each other via threaded bolts, 70, 70″and 71, 71″, wherein the threaded bolts, 70, 70″; 71, 71″ form two pairs, which are allocated to one crankshaft 4, 6 each.

The bearing block 7 is provided with two circular bearing grooves, 72, 73, half of which are formed in the lower bearing block section 7″and in the upper bearing block section 7″. Into the respective bearing groove 72, 73, a roller bearing 74, 75, is inserted, which is mounted with its respective radially interior bearing race 74″, 75, in a rotatably fixated manner onto the respective bearing section 67, 47 of the respective crankshaft 6, 4. The respective exterior bearing race 74″, 75″, of the respective bearing 74, 75, is engaged in a rotatably fixated manner between the lower bearing block section 7′ and the upper bearing block section 7″.

At least one of the two bearing block sections 7′, 7″, is provided in one piece and thereby establishes a rigid connection between the two crankshaft bearings 74, 75.

Though in the embodiment both bearing block sections 7′, 7″, are provided in one piece, alternatively one of the bearing block sections can be provided split vertically, and thus consist of two clamshell bearing holders, clamping the respective bearing of a crankshaft at the other one piece bearing block.

Though in the embodiment roller bearings are shown for supporting the respective crankshafts, alternatively also straight bearings can be provided.

Twin crankshaft engines require, besides a constant transfer of the crankshaft forces, a connection of the synchronization gears, which is possibly without clearance on the one hand, in order to allow a vibration free rotation reversal of the crankshafts, and on the other hand, to synchronize the rotation of the crankshafts with an angular offset as small as possible.

Since in particular in light weight engines, the crankcases are made from different materials, than the crankshafts or the synchronization gears, in a device according to the invention, the crankshaft bearings 74, 75, of both crankshafts 4, 6, are received in a common bearing block 7 forming a bearing support structure. The bearing block 7 is made from a material with a first thermal expansion coefficient and the synchronization gears 42, 62, are made from a material with a second thermal expansion coefficient. The dimensions of the bearing block 7 and the synchronization gears 42, 62 are matched in radial direction, in particular in the direction of the plane defined by the two crankshaft rotation axes X, X′, in consideration of the first and the second thermal expansion coefficient, in a manner so that the thermal expansion of the bearing block 7 between the two rotation axes X, X′, is substantially equal to the thermal expansion of the synchronization gears 42, 62, between the two rotation axes X, X′.

Hereby it is accomplished, that the distance x between the two crankshaft rotation axes X, X′, during a thermal expansion of the bearing block 7, due to the substantially elevated engine temperature when the engine is warm, increases, but this increase of the distance is compensated by the synchronization gears 42, 62, between the two crankshaft rotation axes X, X′, expanding substantially by the same amount. Thereby, the engagement of the synchronization gears 42, 62, in the area of the meshing teeth remains constant over almost the entire operational temperature range of the engine, so that neither thermally increased tooth forces nor an excessive tooth clearance are created.

The bearing block 7 and the synchronization gears 42, 62, can either be made from a material with the same thermal expansion coefficient or even from the same material.

In particular when the diameter of the bearing sections 67, 68, of the respective crankshafts 4, 6, differs from the diameter of the crankshaft sections, where the synchronization gears 42, 62, are mounted, in case the synchronization gears 42, 62, are not provided integrally with the respective crankshaft 4, 6, it is advantageous for the crankshafts 4, 6, to be made from a material having a third thermal expansion coefficient wherein the dimensions of the bearing block 7, the crankshafts 4, 6, and the synchronization gears 42, 62, in a radial direction and the first, the second and the third thermal expansion coefficient are matched to each other, so that the thermal expansion of the bearing block 7 and of the bearing sections 47, 4; 67, 68 of the crankshafts 4, 6 are substantially equal to the thermal expansion of the synchronization gears 42, 62, and the crankshaft sections, where the synchronization gears 42, 62, are mounted.

With this design of the reciprocating piston combustion engine according to the invention, also the crankshafts are included into the thermal expansion compensation between the crankshaft axes X, X′.

Also here the bearing block 7, the synchronization gears 42, 62, and the crankshafts 4, 6, can be made from the same material.

Though the embodiment shows a twin crankshaft engine with two in line piston cylinder units, the invention can also be used with single cylinder engines or with engines with more than two piston cylinder units. Also it is not mandatory that the crankshafts are provided as face crankshafts as shown in the embodiment with bearing blocks 7, 7A provided between the crankpins 40, 45, 60, 65, receiving the piston rods 3, 3′, 5, 5′. Respective crankpins can also be located between the particular bearing blocks.

In FIG. 4 an alternative embodiment similar to the embodiment shown in FIG. 3 is illustrated. The bearing block 107, with its lower bearing block section 107′ and with its upper bearing block section 107″, is provided with a lateral extension 107′″, on one end protruding from the engine housing 26 into a gear box 28, mounted to the engine housing 26. In the extension 107′″ of the bearing block 107, a drive gear 8 with a driveshaft 80 is supported in the bearing block 107 in the same manner as the synchronization gears 42, 62. The drive gear 8 meshes with the neighboring synchronization gear 62, so that the torque generated by the twin crankshaft engine is transferred to the drive gear 8 and to the driveshaft 80 rotationally fixated to it.

Also the drive sprocket 8 is made from a material with a thermal expansion coefficient corresponding to the thermal expansion coefficient of the bearing block 7. In addition also the driveshaft 80 supporting the drive gear 8 in the bearing block can be made from the same material as the bearing block 7.

Since the bearing block 107 is integrally formed with the lateral extension 107′″ in the same way as this has been described in the example of FIG. 3, the same advantages with respect to temperature compensation are also achieved for the gear pairing of the synchronization gear 62 and the drive gear 8 between their axes X′ and X″.

In the embodiment according to FIG. 3, and also in the embodiment according to FIG. 4, through the above described matching of the geometric dimensions in radial direction and through the selection of materials with respective thermal expansion coefficients, a constant, minimized gear clearance during the different thermal operational conditions of the reciprocating piston combustion engine is achieved.

FIG. 5 shows a particular design of a reciprocating piston combustion engine, wherein the bearing block 207 also comprises a lower bearing block section 207″and an upper bearing block section 207″, which are connected in the same manner as it is illustrated in the example of FIG. 3. The bearing block 207, however, is connected at its upper end pointing towards the cylinder 2 with two protrusions 208, 209, pointing towards the cylinder 2, through threaded bolts 270, 271. These protrusions are connected via threaded bolts 210, 211, which are only shown schematically, to the cylinder 2 and to the cylinder head 24 in a solid manner. In this manner, the vertical tension and compression forces, generated in the combustion chamber 22, are directly transferred via the threaded bolts 210, 211, and the protrusions 208, 209, between the cylinder head 24 and the bearing block 207, so that these forces do not have to be transferred via the engine housing. The engine housing can thereby be provided light in particular, whereby a low weight of the reciprocating piston combustion engine can be achieved. Also, when choosing the material for the engine housing, a material with lower strength, but with higher thermal conductivity can be selected, so that the engine housing can substantially contribute to the cooling of the engine.

The parallel two cylinder engine, briefly called twin, constitutes the most compact kind of two cylinder engine design. The cooling jackets around the cylinders and the cylinder heads can be integrated and do not require failure prone connecting tubes. The whole valve train can be provided through a single camshaft drive and two camshafts reaching over both cylinders. This enables a functionally very stiff design and leads to a unit that can be produced in a very economical manner.

The invention is not limited to the above embodiment, which only serves to generally explain the core idea of the invention. Within the scope of the invention a device according to the invention can also be provided in other embodiments, besides the ones described above. In particular, the device can hereby have features, which are a combination of the respective features of the claims.

Reference numerals in the claims, the description and in the drawings, only serve a better understanding of the invention, and do not restrict the scope of the invention.

1. A reciprocating piston combustion engine with
at least one cylinder (2), in which a piston (1) is arranged, so it can be moved in a reciprocating manner;
a first crankshaft (4);
a second crankshaft (6);
wherein the first crankshaft (4) and the second crankshaft (6) extend in parallel and rotate synchronously in opposite directions;
wherein the rotation axes (X, X′) of the two crankshafts (4, 6) extend in parallel with a common cylinder midplane (Z), laterally offset relative to it;
wherein a first piston rod and second piston rod (3, 5) are arranged at the reciprocating piston (1), so that
the first piston rod (3) is pivotably connected with its first end to the reciprocating piston (1), and rotatably connected with its second end to a crankpin (40) of the first crankshaft (4) and
the second piston rod (5) is pivotably connected with its first end to the reciprocating piston (1), and is rotatably connected with its second end to a crankpin (60) of the second crankshaft (6), and
wherein the crankshafts (4, 6) are engaged with each other through synchronizing gears (42, 62),
characterized in that
the two crankshafts (4, 6) are supported in at least one common bearing block (7; 107;
the bearing block (7; 107; 207) is made of a material with a first thermal expansion coefficient,
the synchronizing gears (42, 62) are made of a material with a second thermal expansion coefficient; and
the dimensions of the bearing block (7; 107; 207) and the synchronizing gears (42, 62) in the radial direction, and the first and the second thermal expansion coefficients, are matched so, that the thermal expansion of the bearing block (7; 107; 207) occurring between the two axes of rotation (X, X′) is equal to the thermal expansion of the synchronizing gears (42, 62).

2. A reciprocating piston combustion engine according to claim 1 characterized in that
the crankshafts (4, 6) are made of a material with a third thermal expansion coefficient, and
the dimensions of the bearing block (7; 107; 207), the crankshafts (4, 6), and the synchronizing gears (42, 62) in radial direction, and the first, second and third thermal expansion coefficient are matched so, that the thermal expansion of the bearing block (7; 107; 207) and the bearing sections (47, 48; 67, 68) of the crankshafts (4, 6) supported therein, are substantially equal to the thermal expansion of the synchronizing gears (42, 62) and the crankshaft sections on which the synchronizing gears (42, 62) are mounted.

3. A reciprocating piston combustion engine according to claim 1 characterized in that
the bearing block (7; 107; 207) and the synchronizing gears (42, 62) respectively are made of materials with the same thermal expansion coefficient.

4. A reciprocating piston combustion engine according to claim 3 characterized in that
also the crankshafts (4, 6) are made of a material with the same thermal expansion coefficient as the material of the bearing block (7; 107; 207) and the material of the synchronizing gears (42, 62).

5. A reciprocating piston combustion engine according to claim 3 characterized in that
the bearing block (7; 107; 207) and the synchronizing gears (42, 62) are made of the same material.

6. A reciprocating piston combustion engine according to claim 4 characterized in that
the bearing block (7; 107; 207), the synchronizing gears (42, 62), and the crankshafts (4, 6) are made of the same material.

7. A reciprocating piston combustion engine according to claim 6 characterized in that
at least two bearing blocks (7, 7A) are provided for the supporting of the crankshafts (4, 6).

8. A reciprocating piston combustion engine according to claim 6 characterized in that
at least two in line piston-cylinder units are provided.

9. A reciprocating piston combustion engine according to claim 6 characterized in that
the bearing block (107) supports at least one drive gear (8) meshing with at least one of the synchronizing gears (42, 62), and
also the drive gear (8) is made of a material with a thermal expansion coefficient equal to the thermal expansion coefficient of the bearing block (107).

10. A reciprocating piston combustion engine according to claim 9 characterized in that
the drive gear (8) and the drive shaft (80) supporting the drive gear (8) in the bearing block (107) are made of the same material as the bearing block (107).

11. A reciprocating piston combustion, in particular according to one of the preceding claims with
at least one cylinder (2), in which a piston (1) is arranged, so it can be moved in a reciprocating manner;
a first crankshaft (4);
a second crankshaft (6);
wherein the first crankshaft (4) and the second crankshaft (6) extend in parallel and rotate synchronously in opposite directions;
wherein the rotation axes (X, X′) of the two crankshafts (4, 6) are parallel with a common cylinder midplane (Z) and laterally offset relative to it;
wherein a first piston rod and a second piston rod (3, 5) are arranged at the reciprocating piston (1), so that
the first piston rod (3) is pivotably connected with its first end to the reciprocating piston (1), and rotatably connected with its second end to the crankpin (40) of the first crankshaft (4), and
the second piston rod (5) is pivotably connected with its first end to the reciprocating piston (1), and rotatably connected with its second end to a crankpin (60) of the second crankshaft (6), and
wherein the crankshafts (4, 6) are engaged with each other through meshing synchronizing gears (42, 62),
characterized in that
the two crankshafts (4, 6) are supported in at least one common bearing block (207), which is separate from the crankcase, and
the bearing block (207) is connected to the cylinder (2) and/or the cylinder head (24).

12. A reciprocating piston combustion engine according to claim 11 characterized in that
the bearing block (207) has at least one upper extension (208, 209), pointing towards the cylinder (2), provided with reception means for mounting elements (210, 211) for connecting the bearing block (207) to the cylinder (2) and/or the cylinder head (24).
